(19) United States
(12) Patent Application Publication
(10) Pub. No.: US 2022/0194506 A1
(43) Pub. Date: Jun. 23, 2022

(54) Rechargeable Bicycle Light

(71) Applicant: Roger Lionel David Sparrow, Pulborough (GB)

(72) Inventor: Roger Lionel David Sparrow, Pulborough (GB)

(21) Appl. No.: 17/645,428

(22) Filed: Dec. 21, 2021

(30) Foreign Application Priority Data
Dec. 22, 2020 (GB) GB2020323.8

(51) Int. Cl. B62J 6/015; F21V 23/06; F21L 4/08; F21V 23/04; H05B 45/10

(52) U.S. Cl. CPC B62J 6/015; F21V 23/06; F21Y 2115/10; F21V 23/0414; H05B 45/10; F21L 4/085

(57) ABSTRACT

A light for an ebike, comprising three LEDs, a rechargeable light battery, a charging port, to receive power from an accessory port of an ebike, and control circuitry, programmed so that when the power drain of the LEDs is less than the power input from the accessory port, the battery can be charged and when the power drain of the LEDs is greater than the power input from the accessory port the LEDs can draw power from both the battery and the accessory port.

This application claims the benefit of priority and is entitled to the filing date pursuant to 35 U.S.C. § 119(a) of Great Britain Patent Application GB2020323.8, filed Dec. 22, 2020, the content of which is hereby incorporated by reference in its entirety.

The present invention relates to a bicycle light and particularly, but not exclusively, for an electrically powered pedal bicycle.

Electrically powered pedal bicycles (known as “ebikes”) have become increasingly popular in recent years, including as mountain bikes, enabling quicker ascent and more down-hill runs in a day. However, these runs can often take place at times of low light or even night time. For this it is desirable, in the interests of safety, to have a high intensity light for the fast descent in order to minimise the likelihood of accidents. Similarly ebikes for road use can require high intensity lights. In general, a rider may at any given time require a high intensity light.

The most commonly used bicycle lights are LED lights. These are small and compact, suiting them for bicycle handle bar or helmet mounting. Nevertheless high enough intensity e.g. for fast downhill or other use implies high current drain from the light's battery.

Known bicycle lights have limited capacity batteries, such that a high intensity (e.g. downhill) run is liable to exhaust a light's battery. Further, bicycle lights typically use only 4.2 volts to power the LEDs.

It is known for batteries on ebikes to have a limited wattage accessory port, which can power lights at limited intensity only. This is typically a 6 v or 12 v port. This provides enough for regular illumination but typically provides insufficient power for light intensity at the higher levels sometimes required during a ride.

A known light can be powered at lower wattage for ascending a hill and a high power for descending, as described in GB2498441, the abstract of which is as follows: “A bicycle lamp has a body 100, a battery 104 mounted in the body 100, an LED 105 and a means for determining a rate of climb of the bicycle to which the lamp is mounted. A controller incrementally decreases current supplied from the battery to the LED is response to a determination that the bicycle is being ridden up hill. The rate of climb may be sensed using an accelerometer or a GPS device. The current supplied to the LED may also be controlled in response to a detected temperature”.

Known lights have a single port for charging and powering an extra light such as a red rear light. Our prior patent, GB 2462935, has the following abstract referring to its Figures: “A lamp powered by batteries 4 has an external socket 3 which can be used to provide power to an external device, or to recharge the batteries 4. The lamp has a power management circuit 11. It includes an integrated circuit (12, FIG. 5) for control of the lamp and is controlled by operation of a switch 7”.

It is known to provide large capacity batteries for high intensity lights, but these are heavy in accordance with their increased size. Larger batteries are more expensive and physically take up more space and can obstruct bike controls.

### SUMMARY

The object of the present invention is to provide an improved bicycle light.

### BRIEF DESCRIPTION OF THE DRAWINGS

To help understanding of the invention, a specific embodiment thereof will now be described by way of example and with reference to the accompanying drawings, in which:

FIG. 1 is a schematic cross-sectional view of a bicycle light of the invention;

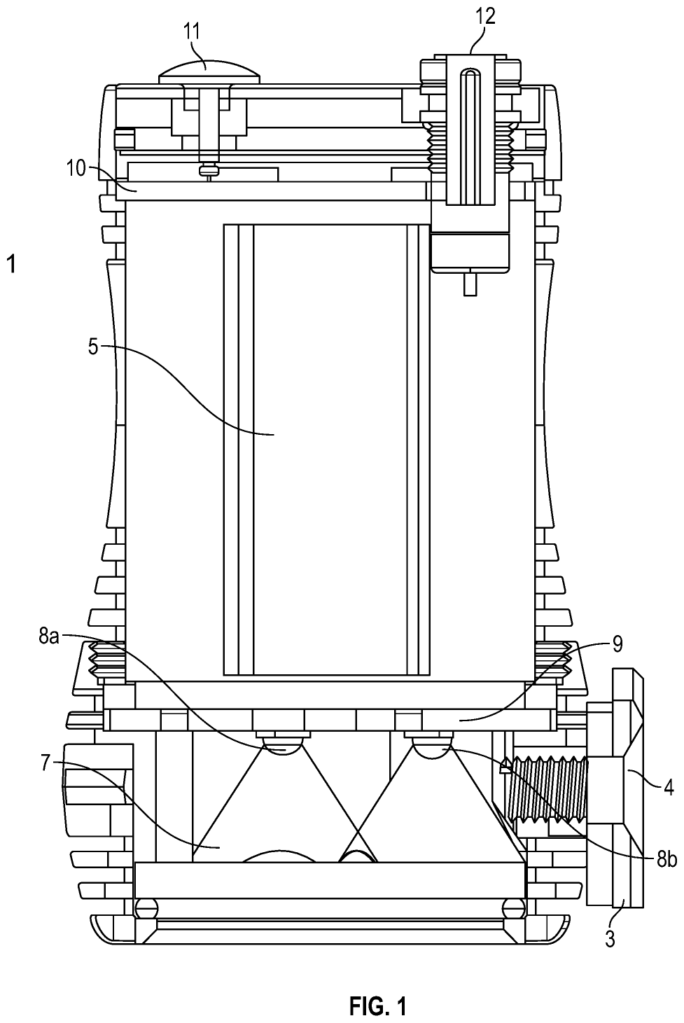

FIG. 2 is a schematic view of the assembled light of FIG. 1 from the side and above; and

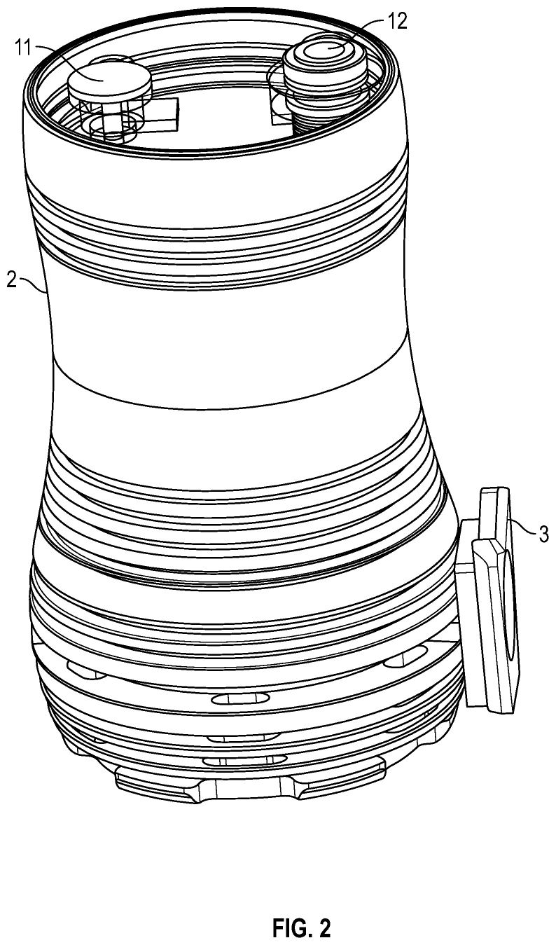

FIG. 3 is a schematic view of the unassembled light of FIG. 1.

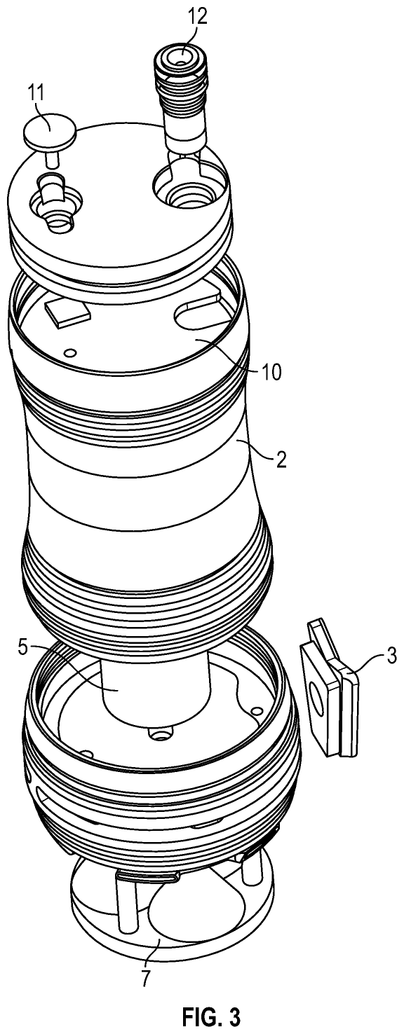

Referring to the drawings, a light 1 for a bicycle has a body 2, of turned aluminium. For mounting on a bicycle handlebar it has cleat 3 attached to the body by bolt 4, which can be attached to a bracket and clamped to a handlebar in a conventional, demountable manner.

### DETAILED DESCRIPTION

Accordingly, the invention provides a light for an ebike, comprising
a light emitter,
a rechargeable light battery,
an electrical input, e.g. charging port, to receive power from an external source, e.g. power output from an ebike, and
control circuitry, programmed so that when the power drain of the light emitter is less than the power input from the external source, the light battery can be charged or the light emitter does not draw power from the light battery, and when the power drain of the light emitter is greater than the power input from the external source the light emitter can draw power from the battery or from both the battery and the power input.

Suitably, the light emitter comprises one or more LEDs.

The electrical input on the light can be a recharging port, suitably adapted for connection to the output from the ebike. Another option is for the electrical input on the light to be hard wired to ebike power.

In use of the light, when the power drain of the light (e.g. the one or more LEDs) is less than the power input from the charging port, the light battery can be charged from the ebike.

As will be appreciated, the light can in use continually receive power from the ebike resulting in a net gain to the light battery when the light is on low power output (meaning lower than the power received from the ebike) and a net loss when the light is on high power output (meaning higher than the power received from the ebike).

In use of the light, the emitter can draw power from the light battery while the power from the ebike is supplied to the light battery, whether for net charging of the light battery or for when the power drawn by the emitter exceeds the power output from the ebike. In this context, and elsewhere herein, reference to charging the light battery is reference to net charging. Thus, if the light emitter is drawing a given amount of power from the light battery and the ebike is supplying a greater amount of power to the light battery then the light battery is being charged, and if the light emitter is drawing a given amount of power from the light battery and the ebike is supplying a lesser amount power to the light battery then the light battery is not being charged; it is being drained or discharged.

In preferred embodiments, the one or more LEDs operate at variable intensity. All LEDs are illuminated when the light is on, and the LED intensities vary according to power use, optionally selected by the user via a switch on the light.

In other embodiments, the light has a plurality of LEDs and high intensity output is achieved by switching on one or more additional LEDs. For example at low power output 1 LED is illuminated, and the light battery is net charged, then at medium power output 2 LEDs are illuminated and there is little or no net charging of the light battery, and then at high output 3 LEDs are illuminated for maximum light output and the light battery is net drained.

The light may include a switch to choose between different intensity LED output.

Lights of the invention may be for mounting on a helmet.

Lights of the invention may be for mounting on a jacket.

In preferred embodiments, the lights are for mounting onto a bike frame, especially onto the handlebar.

The power output from the ebike may also be referred to as the ebike auxiliary port or ebike accessory port.

A specific embodiment of the invention provides a light for an ebike, comprising
3 LEDs,
a rechargeable light battery,
a charging port, to receive power from an accessory port of an ebike,
control circuitry, programmed so that when the power drain of the LEDs is less than the power input from the accessory port, the battery can be charged and when the power drain of the LEDs is greater than the power input from the accessory port the LEDs can draw power from the light battery or from both the battery and the charging port.

Preferably, in use of the light, power from the ebike is continually supplied to the light battery, both for net charging of the light battery and also for when the power drawn by the emitter exceeds the power output from the ebike, such that the light battery is net being drained.

Preferably, in all embodiments, the battery can also be charged by another source other than the ebike, e.g. from a domestic charger plugged into mains power.

Control circuitry can adjust the light setting so that as the battery reaches fully discharged state the output of the light draws the same power as received from the ebike power output.

In further specific embodiments of the invention there is provided a light for use with an ebike with an accessory port, the light comprising:
a rechargeable, relatively low wattage light battery,
a recharging socket,
an LED chip array,
means for controlling powering of the LED chip array from the rechargeable battery at a plurality of illumination levels, including a relatively high wattage illumination level and
an input point adapted to receive power for the light from an ebike accessory port at a relatively high voltage and at a relatively low wattage, lower than that of the relatively high wattage illumination level.

Typically we envisage that, for relatively high illumination level use, e.g. during a short duration descent, the battery can be used, especially in combination with the ebike input, and then the battery can be net charged from the ebike accessory port at another time of low illumination level use, e.g. during a longer corresponding ascent.

The light emitter will preferably be made up of one or more LEDs arranged in an array. Normally, there will be a plurality of LEDs, preferably between two and six, usually three. It is possible that the LED array will be a regular pattern of lights conforming to the external shape of the light, usually a circle. However, the LED array need not be restricted to the external shape of the light, the array can be any arrangement of the LEDs. It is preferred that there are three large LEDs arranged in a substantially triangular array within the circular light, with three smalls LEDs located in the outer spaces therebetween.

In use of the light, with the ebike battery not being required for propulsion during the descent, power from it can augment that from the light battery during descent. Typically, the output from the ebike to the accessory port is relatively constant, regardless of how much power is being used for the ebike pedaling assistance motor. An additional LED chip array may be provided to utilise this ebike battery power, with the total LED chip array maximum wattage exceeding that of the maximum light battery wattage. The additional LED chip array may be controlled manually, but is preferably controlled by the control means.

The light can be adapted to draw power from the ebike battery at all times, both ascent, level riding, descent and waiting, in preference to from the light battery, to conserve this for high intensity lighting whenever required, e.g. during descent. High intensity output from the light can, in some embodiments, be switched on automatically, e.g. triggered by detecting a descent. Known monitors to detect descent can be used with the light control circuitry.

Normally the input port will be of a type able to power an extra, e.g. rear, light, for normal road use. Whilst we can envisage the re-charging point to be a permanent wiring point, normally it will be a socket allowing removal of the light from its ebike.

Normally the rechargeable battery will comprise several cells in series. There may be more than one cell series, these being connect in parallel.

Usually the cells will be electrochemical cells. However, we can envisage that capacitor can be employed for at least short term storage of electrical power, e.g. for the length of the descent, whereby the electrical power for the high intensity light descent can be at least partially capacitively stored.

Normally the light battery will be housed in a body of the light. However it is conceivable that the battery may be provided remotely from the light body.

An advantage of the invention is that high intensity output is available when needed but the light battery size can be kept small because it can be recharged between high intensity output periods. The smaller battery size keeps down overall light size and weight and price.

Internally of the body, it has a battery 5. In front, a lens 7 is positioned to focus the output from LED emitters 8a, 8b, 8c (8c not shown) mounted on and as part of LED chip array 9, to be powered by the battery under control of a control board 10 incorporating a control circuit and a manual switch 11. A recharging socket 12 is provided. For convenience of understanding the drawings, wired connections between the battery, control circuit and LED chip array and between the recharging socket and the control board are not shown.

The socket is connected to the battery via a charge controller (not shown).

The charge controller is adapted to detect the voltage on a charging cable connected to the socket so that the battery can be charged when connected to an ebike or to an external charger:
if the charging cable voltage is nominally that of the battery—c. 4 volts, the controller applies the charging voltage to the battery;
if the charging voltage is significantly higher, such as 6 or 12 volts, as from an ebike battery or a mains to DC charger, the charging controller switches the voltage to be applied to a voltage converter circuit, which reduces the 6 or 12 volts DC to 4 volts DC for application to the battery.

In one use of a highest intensity of the LED array, as selected by the manual switch 11 and controlled by the circuit 10, the power consumed by the LEDs exceeds that available from an auxiliary port of an ebike battery. In this mode, the LEDs are powered by the light battery continually topped up by the ebike, hence by a combination of the ebike power and the battery power. The light battery is able to power the LEDs of the light at full brightness even without receiving the ebike power, though with no ebike power input it will discharge more quickly. In another mode, the power consumed by the LEDs is reduced and is less than that available from the auxiliary port of the ebike. In this other mode, the LEDs are powered by the ebike power and the battery is, at the same time, net recharged. The light can also be used as a stand-alone light, meaning independently from an ebike; its battery life will be more limited than when connected to ebike power

It is envisaged that the light can be used in this high intensity mode on a downhill descent of the ebike to which it is fitted, as more light is needed for the rider, and then recharged during the slower uphill ascent with electrical assistance of the ebike, when high intensity light is not needed. In other words the power required for the high intensity illumination during the fast descent can be replaced at a slower rate during the longer, slower ascent and/or possibly a wait prior to the next descent.

Separately, the bike light battery can be recharged at any time that the output from the LEDs requires less power than the ebike provides. The light battery will thus see a net gain in capacity when on a low setting but net loss on a high output setting.

The invention is not intended to be restricted to the details of the above-described embodiment of a handlebar mounted bicycle light. It can be a helmet mounted light, in which case the battery can be mounted in a belt carrier with the recharging port being at the battery and a cable connecting the battery to the light per se on the helmet. Further, in an embodiment the level of illumination may be controlled automatically by the control circuit in accordance with sensed gradient being descended as opposed to by the manual switch 11.

The invention thus provides a rechargeable bicycle light.

1. A light for an ebike, comprising
a light emitter,
a rechargeable light battery,
an electrical input to receive power from an external source
control circuitry, programmed so that when a power drain of the light emitter is less than the power input from the external source, the rechargeable light battery can be charged or the light emitter does not draw power from the rechargeable light battery, and when the power drain of the light emitter is greater than the power input from the external source the light emitter can draw power from the rechargeable light battery or from both the rechargeable light battery and the power input.

2. The light of claim 1, wherein the electrical input is a charging port.

3. The light of claim 1, wherein the external source is a power output from an ebike.

4. The light of claim 1, wherein the light emitter comprises one or more LEDs.

5. The light of claim 4, wherein the one or more LEDs can operate at variable intensity.

6. The light of claim 4, comprising a switch to choose between different intensity outputs of the one or more LEDs.

7. The light of claim 1, wherein the electrical input on the light is a recharging port.

8. The light of claim 1, wherein when the power drain of the light emitter is less than the power input from the electrical input, the rechargeable light battery can be charged from the ebike.

9. The light of claim 1, wherein the light can continually receive power from the ebike resulting in a net gain to the rechargeable light battery when the light is on low output and a net loss when the light emitter is on high power output.

10. The light of claim 1, wherein the light emitter can operate at variable intensity.

11. The light of claim 1, comprising a switch to choose between different intensity outputs of the light emitter.

12. The light of claim 1, for mounting on a helmet.

13. The light of claim 1, for mounting on a jacket.

14. A light for an ebike, comprising
three LEDs,
a rechargeable light battery,
a charging port, to receive power from an accessory port of an ebike,
control circuitry, programmed so that when the power drain of the LEDs is less than the power input from the accessory port, the rechargeable light battery is charged and when the power drain of the LEDs is greater than the power input from the accessory port the LEDs draw power from the rechargeable light battery or from both the rechargeable light battery and the accessory port.
